(19) United States
(12) Patent Application Publication
(10) Pub. No.: US 2017/0013100 A1
(43) Pub. Date: Jan. 12, 2017

(54) WIRELESS OR CELLULAR PHONE DEVICE CASE WITH AN AIR TUBE RETRACTABLE EAR BUD HEADSET

(71) Applicant: BARBARA J. WURDEN, CATHEDRAL CITY, CA (US)

(72) Inventor: BARBARA J. WURDEN, CATHEDRAL CITY, CA (US)

(21) Appl. No.: 15/206,207

(22) Filed: Jul. 8, 2016

Related U.S. Application Data
(60) Provisional application No. 62/189,819, filed on Jul. 8, 2015.

(51) Int. Cl. H04M 1/02; H04B 1/3827; H04B 1/3888; H04R 1/10

(52) U.S. Cl. CPC H04M 1/0258; H04R 1/1033; H04B 1/3838; H04B 1/3888

(57) ABSTRACT

A wireless or cellular phone device case with an air tube anti-radiation retractable ear bud headset for providing an easily accessible communication component within a portable wireless or cellular phone device case while limiting transmitted radiation leakage. The wireless or cellular phone device case with air tube anti-radiation retractable ear bud headset generally includes a wireless or cellular phone device case containing a housed retractable phone cord and air filled anti-radiation tube.

### RELATED APPLICATION DATA

This application claims the priority date of provisional application No. 62/189,819 filed on Jul. 8, 2015, which is herein incorporated by reference in its entirety.

### BACKGROUND

The present invention relates generally to a portable mobile device unit, and more specifically it relates to an integrated cover unit for a wireless or cellular phone device, and other portable mobile devices, and which includes an air filled wireless tube anti-radiation retractable earphones set for providing an easily accessible communication component within a portable wireless or cellular phone device case while limiting transmitted radiation leakage when connected to a wireless or cellular phone.

### SUMMARY

An object of the present invention is to provide a wireless or cellular phone device case with an air filled wireless tube anti-radiation retractable earphone set for providing an easily accessible communication component within a portable wireless or cellular phone device case that prevents the biological effects from DNA damage to brain cells that can result with prolonged cellular phone when next to the head of a user use by limiting the transmitted radiation leakage and protecting the phone user from electromagnetic frequency damage.

Another object is to provide a wireless or cellular phone device case with an air filled wireless tube anti-radiation retractable earphone set that allows, encourages, and trains children to consistently use an anti-radiation headset resulting in the prevention of radiation damage on developing brains.

Another object is to provide a wireless or cellular phone device case with an air filled wireless tube anti-radiation retractable earphone set that gives a readily available, easily stored, and tangle free phone cord as a hands free option for cell phone users.

Another object is to provide a wireless or cellular phone device case with an air filled wireless tube anti-radiation retractable earphone set that gives users a replaceable hands free headset option resulting in the ease of headset replacement without replacing the entire case device.

Another object is to provide a wireless or cellular phone device case with an air filled wireless tube anti-radiation retractable earphone set that gives more options and possibilities for stylish designs on cellular phone device cases.

An integrated cover unit for a portable mobile device, comprising a multi-piece cover for said portable mobile device; and a retractable earphone unit removably coupled to an inner portion of said cover. The cover further comprises a top piece and a bottom piece. The unit further comprises a spool and an earphone set, and further wherein said retractable earphone unit further comprises a spool and an earphone set, and further wherein said earphone set further comprises an audio plug, an electrical cord, a microphone, a plurality of ferrite beads, hollow tubing, and a plurality of ear pieces; and wherein said cord of said earphones are configured to wrap around said spool; and tubing is comprised of a flexible plastic material. The earphones may be extended out from said spool and partially retracted around said spool up until said microphone.

An integrated cover unit for a portable mobile device, comprising a one-piece cover for said portable mobile device; and a retractable earphone unit removably coupled to an inner portion of said cover; and further comprises a compartment door for allowing a user to situate said retractable earphone unit within said inner portion of said cover. The retractable earphone unit further comprises a spool and an earphones set, and further wherein said retractable earphone unit further comprises a spool and an earphone set, and further wherein said earphone set further comprises an audio plug, an electrical cord, a microphone, a plurality of ferrite beads, hollow tubing, and a plurality of ear pieces; and wherein said cord of said earphones are configured to wrap around said spool. Tubing is comprised of a flexible plastic material. The earphones may be extended out from said spool and partially retracted around said spool up until said microphone.

An integrated cover unit for a portable mobile device, comprising a cover for said portable mobile device; a retractable earphone unit removably coupled to an inner compartment of said cover; and wherein said cover further comprises an internal housing for an earphone set of said retractable earphone unit. The retractable earphone unit further comprises a spool and an earphone set, and further wherein said retractable earphone unit further comprises a spool and an earphone set, and further wherein said earphone set further comprises an audio plug, an electrical cord, a microphone, a plurality of ferrite beads, hollow tubing, and a plurality of ear pieces. The cord of said earphones are configured to wrap around said spool; wherein said earphones may be extended out from said spool and partially retracted around said spool.

### BRIEF DESCRIPTION OF THE SEVERAL VIEWS OF THE DRAWINGS

FIG. 1 illustrates an example of an integrated cover unit for a portable mobile device showing a view of a front portion of the cover unit in an open state.

FIG. 2 illustrates an example of an integrated cover unit for a portable mobile device showing a view of a bottom portion of the cover unit in an open state.

FIG. 3 illustrates a front view of another embodiment of an integrated cover unit with the front portion and the bottom portion in a closed state.

FIG. 4 illustrates a side view of the integrated cover unit.

FIG. 5 illustrates an alternate embodiment of an integrated cover unit for a portable mobile device.

FIG. 6 illustrates a side view of the alternate embodiment of the integrated cover unit of FIG. 5.

FIG. 7 illustrates yet another embodiment of an integrated cover unit for a portable mobile device.

FIG. 8 illustrates the front portion of another embodiment of an integrated cover unit for a portable mobile device.

FIG. 9 illustrates the bottom portion of the FIG. 8 embodiment of an integrated cover unit for a portable mobile device.

FIG. 10 illustrates a front view of an example embodiment of an integrated cover unit for a portable mobile device.

FIG. 11 illustrates a cross-sectional view of the embodiment of FIG. 10.

FIG. 11A illustrates one embodiment of phone cord cartridge.

FIG. 11B illustrates another embodiment of phone cord cartridge.

FIG. 12 illustrates a bottom view of the embodiment of FIG. 10.

FIG. 13 illustrates another bottom view of the embodiment of FIG. 10.

FIG. 14 a right side view of the cover unit embodiment of FIG. 10.

FIG. 15 a left side view of the cover unit embodiment of FIG. 10.

FIG. 16 illustrates a bottom side view of the cover unit embodiment of FIG. 10.

FIG. 17 illustrates a top side view of the cover unit embodiment of FIG. 10.

FIG. 18 illustrates an operational mode of the embodiment of FIG. 10 in which portable mobile device may be utilized by a user.

FIG. 19 illustrates yet another embodiment of an integrated cover unit for a portable mobile device.

### DESCRIPTION OF THE PREFERRED EMBODIMENTS

The detailed descriptions set forth below in connection with the appended drawings are intended as a description of embodiments of the invention, and is not intended to represent the only forms in which the present invention may be constructed and/or utilized. The descriptions set forth the structure and the sequence of steps for constructing and operating the invention in connection with the illustrated embodiments. It is to be understood, however, that the same or equivalent structures and steps may be accomplished by different embodiments that are also intended to be encompassed within the spirit and scope of the invention.

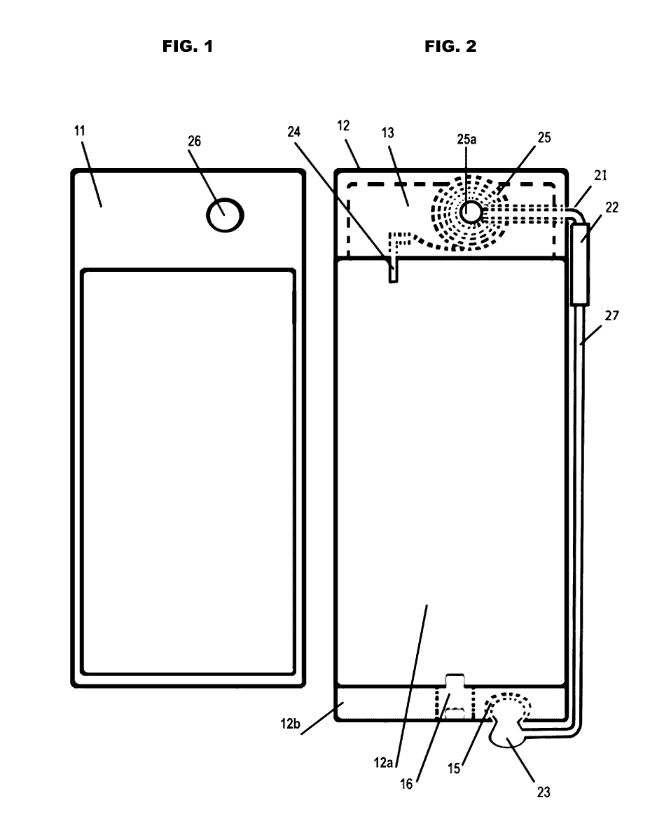

FIGS. 1 and 2 illustrate an example of an integrated cover unit (10) for a portable mobile device (10a) (not shown in this figure), showing a view of a cover for portable mobile device (10a), which may be comprised of a front case shell (11) (FIG. 1) and a bottom case shell (12) (FIG. 2) while in an open or separated state. With respect to FIG. 1, when in a closed state, the front case shell (11) is connected atop of the bottom case shell (12) to enclose and secure the internal contents of cover unit (10) while still enabling a user access to a graphic user interface of the portable mobile device (10a). The front case shell (11) may be connected to the bottom case shell (12) by fastening a pair of complementary grooves together, or in other comparable fastening means that may be known to one of ordinary skill in the art. In an exemplary embodiment, cover unit (10) may be used for LG G5 mobile phone model, but other comparable models, brands, and types of portable mobile devices, such as personal digital assistants, cellular telephones, smartphones, tablets, and other similar computing devices, may be used in connection with cover unit (10) without limiting the scope of the present disclosure.

The shape of cover unit (10) may be large enough in proportional so as to dissuade a user, or otherwise train a user to avoid storing cover unit (10) within user's pocket, jacket, or other clothing item so that the portable mobile device (10a) within cover unit (10) is not in close or prolonged proximity with user's face and body.

With respect to FIG. 2, bottom shell case (12) may be comprised of three internal portions, including an upper compartment (13) for housing a phone cord cartridge (25), a central compartment (12a) for housing the portable mobile device (10a), and a lower compartment (12b) for housing a power port extension unit (16), and ear pieces (23) (discussed below). The outer portion of bottom shell case (12) may be coated with a radiation shield, which may be applied in the form of paint, and may be water-based in nature. The coating may serve to block or reduce exposure to radiofrequency (RF) radiation, microwaves, and electromagnetic frequencies (EMF). Coating may also contain copper particular conductivity properties for shielding against electric field, RF radiation, and electromagnetic interference (EMI).

The power port extension unit (16) may be comprised of one end that may connect to and match a power port input of the portable mobile device (10a) and another end for connecting a power charge of the portable mobile device (10a), thus enabling a user to charge the portable mobile device (10a) during use of the cover unit (10) with portable mobile device (10a).

Phone cord cartridge (25) is designed as a removable unit from cover unit (10), and cartridge (25) may be replaced with another phone cord cartridge (25) depending on such factors, which include, but are not limited to, a user's preference, and wear and tear on the components of phone cord cartridge (25). Phone cord cartridge (25) may be further comprised of a spool (25a) and an earphone set (20). Spool (25a) may be coupled to upper compartment (13) and is configured to allow an electrical cord or cable portion (21) of earphones (20) to be spooled in a generally circular motion into an extended or non-extended state around such spool (25a) depending on use of the earphones (20) by a user. Spool (25) may be connected within upper compartment (13) via a rotatable screw device, or other comparable rotatable element. In situating phone cord cartridge (25) within upper compartment (13) of bottom case shell (12), an audio plug (24) of earphones (20) may be positioned within portable mobile device (10a) with the cord (21) of earphones (20) placed within a recessed opening (50) of a side of upper compartment (13) allowing the cord (21) of earphones (20) to be threaded there within when bottom case shell (12) is connected to the front case shell (11) in a closed state, and when extending or retracting the cord (21) during use. Phone cord cartridge (25) may be further comprised of rounded surface spools, or other comparable spools without limiting the scope of the present disclosure. Spool (25a) may be made of plastic or metal as well as have locking or gripping features that may be known to one of ordinary skill in the art.

As noted above, body housing (12a) of bottom shell case (12) may house a portable mobile device (10a). Portable mobile device (10a) may be housed within body housing (12a) by sliding portable mobile device (10a) into the lower portion of body housing (12a) and connecting it to the power port extension (16), and once connected to power port extension (16), further positioning portable mobile device (10a) within body housing (12a). Further, once the entire body of portable mobile device (10a) is placed within body housing (12a), the audio plug (24) of earphones (20) may be connected to portable mobile device (10a) for audio-related purposes.

In addition to the power port extension unit (16) of lower portion (12b), lower portion (12b) may further be comprised of an ear piece compartment (15) that may house one or more ear pieces (23) when earphones (20) are not in use. Ear piece compartment (15) may be employed for purposes of storage, keeping the ear piece (23) of earphones (20) in sanitary condition, and safeguarding such ear pieces again wear and tear, and other destructive elements. Ear piece compartment (15) may be comprised of an internal mold within lower portion (12b) to fit around the general shape of a particular ear piece (23), or different ear piece shapes.

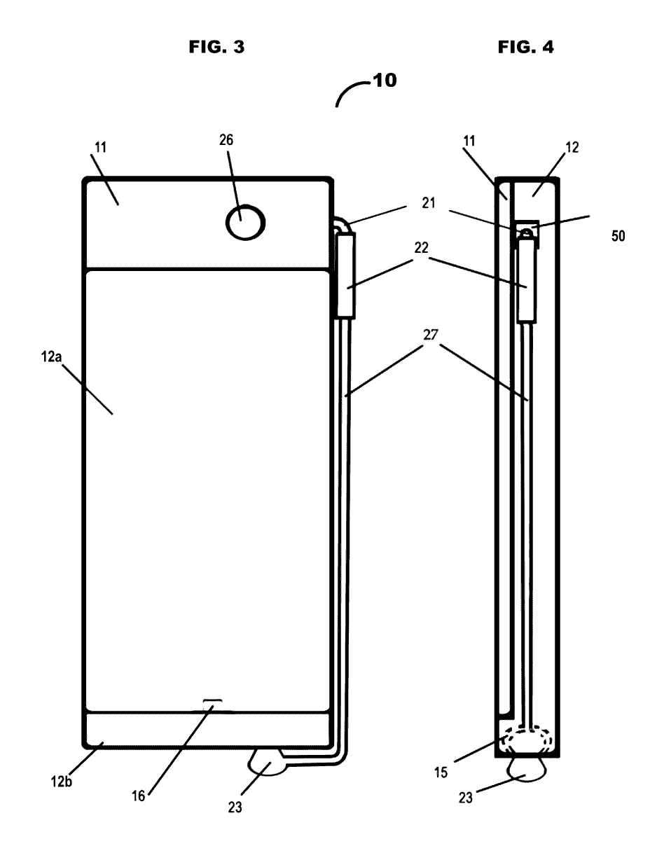

FIG. 3 illustrates a front view of an example embodiment of an integrated cover unit (10) in a closed state, with front case shell (11) and bottom shell case (12) (not shown in this view) connected to one another. Front case shell (11) may be further comprised of button (26), which protrudes out from the surface of front case shell (11) for engaging by a user. Button (26) may be used to engage with and to activate phone cord cartridge (25) for purposes of retracting cord (21) when a user desires to store the earphones (20). Button (26) may be configured to engage with spool (25a) by a variety of mean known to one of ordinary skill in the art. In this view, cord (21) extends out from the side of and along the height of cover (10) with ear piece (23) situated within ear piece compartment (15). When retracting cord (21) by engaging button (26), such retraction action may be stopped or limited along the length of cord (21) by a microphone and/or control element (22) of earphones (20).

Earphones (20) may be further comprised of a tubing (27), which may be coupled at one end to cord (21) via a ferrite bead (38) and at the other end to ear piece (23). One or more ferrite beads (38) may be utilized in connection with any of the embodiments described herein. Tubing (27) may be comprised of air-filled, plastic, wireless tubing in an exemplary embodiment, and sound may travel through tubing (27) to ear pieces (23) through the utilization of stereo acoustic sound travel for tubing technologies already known in the art. Depending on the length of earphones (20), the corresponding length of tubing (27) could also vary. Ferrite beads (38) may be comprised of a hollow cylinder or bead shape composed of ferrite/iron oxide material. Ferrite beads (38) may be used with earphones (30) to facilitate sound travel to ear pieces (23) and may also reduce or remove the amount of high frequency EMI noise found in electronic circuits.

Tubing (27) may be utilized for preventing or reducing the amount of radiation that may be emitted from cord (21) and other elements of earphones (20), including by alleviating direct contact of cord (21) with a user's face and body. In one embodiment, tubing (27) may be comprised of a plastic material that may be flexible or rigid in nature. In another embodiment, tubing (27) may also be comprised of a material that is coated with radiation shielding paint or copper based paint to further enhance the protective capabilities of tubing (27).

FIG. 4 illustrates a side view of an integrated cover unit (10). In this view, both front case shell (11) and bottom shell case (12) are shown in a closed state, and further illustrates earphones (20), including microphone (22) and tubing (27). Also shown in this view is a partial cross-sectional view of ear piece (23) inserted within ear piece compartment (15).

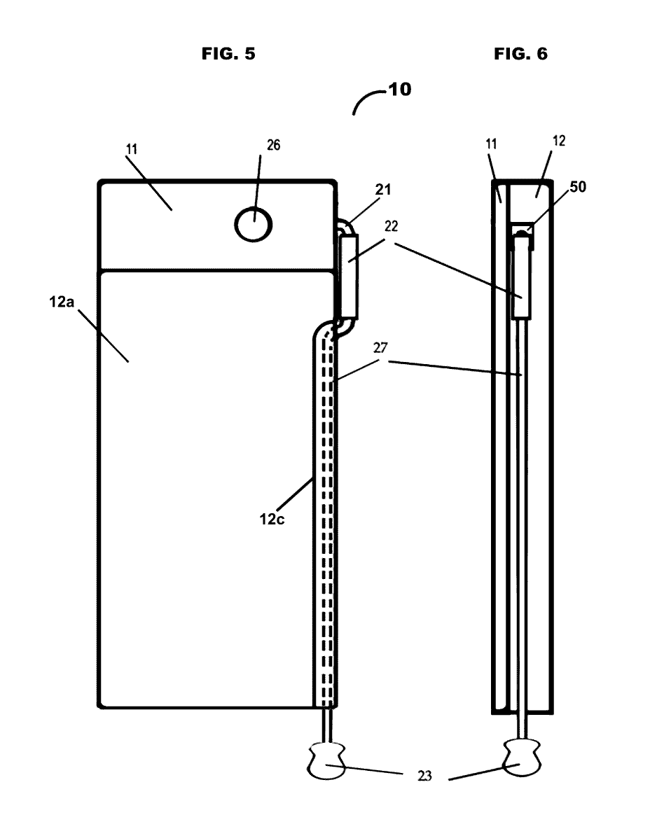

FIGS. 5 and 6 illustrate another example of an integrated cover unit (10) for a portable mobile device (10a) (not shown in this figure). In this example of cover unit (10), bottom shell case (12) does not contain power port extension unit (16) within lower portion (12b). In this embodiment, a user may use a charger to directly connect to the portable mobile device (10). Further, in this alternate embodiment, bottom shell case (12) may be comprised of a channel (35) for housing earphones (20), including tubing (27). FIG. 5 further illustrates a partial cross-sectional view of cover unit (10) to demonstrate the channel (35) along the length of unit (10) that may house a portion of earphones (20). In the embodiment shown in FIG. 5, channel (12c) houses the length of tubing (27). In other embodiments of channel (12c) that may be implemented in accordance with the present invention, channel (12c) may be configured to house the entire portion of earphones (20) that remains external to cover unit (10) when in a retracted position. In yet other embodiments of channel (12c), channel (12c) may be situated within front case shell (11) or configured upon both front case shell (11) and bottom shell case (12). FIG. 6 illustrates a side view of this alternate embodiment, and further illustrates how the tubing (27) may appear when positioned within channel (12c).

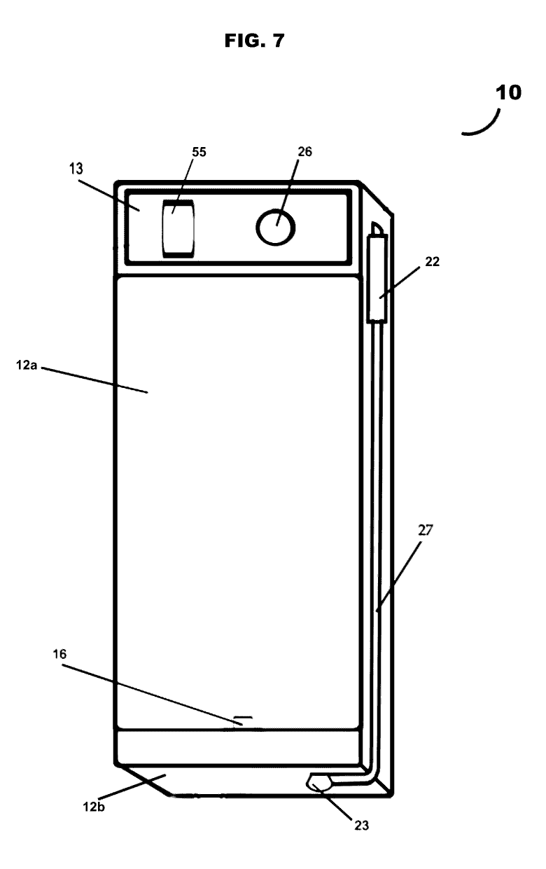

FIG. 7 illustrates yet another embodiment of an integrated cover unit (10) for a portable mobile device (10a) (not shown in this figure). In this embodiment, cover unit (10) is a single piece with front case shell (11) and bottom case shell (12) as a uniform one-piece unit. Further, in this embodiment, cover unit (10) may also comprise a door (55) that may be situated on the front or rear of cover unit (10) for purposes of allowing phone cord cartridge (25) to be positioned within cover unit (10) and connected to portable mobile device (10a).

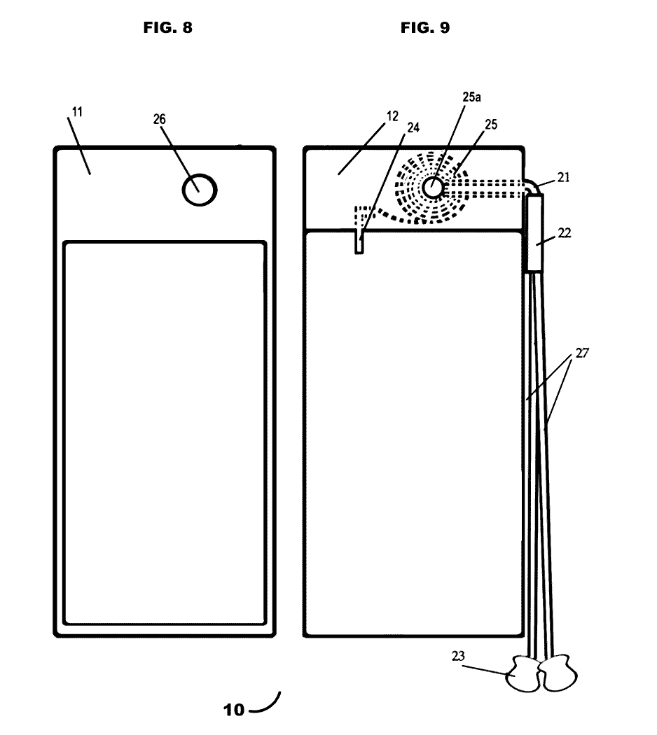

FIGS. 8 and 9 illustrate another embodiment of an integrated cover unit (10) for a portable mobile device (10a) (not shown in this figure). Similar to the embodiment explained in FIGS. 5 and 6, the bottom shell case (12) of cover unit (10) does not contain power port extension unit (16) within lower portion (12b). In this embodiment, the earphones (20) of phone cord cartridge (25) contain two ear pieces (23) instead of one ear piece (23) depending on a user's preferences and needs.

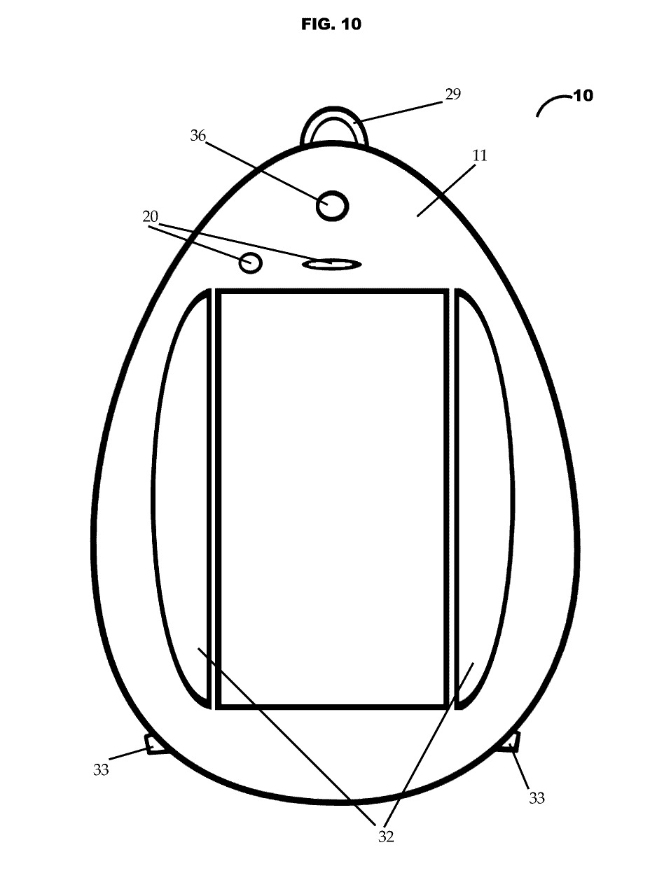

FIG. 10 illustrates a front view of another embodiment of an integrated cover unit (10) for a portable mobile device (10a) (not shown in this figure). In this embodiment of cover unit (10), the shape of cover unit (10) has rounded edges, and may be similar in shape to that of an oval or egg. As discussed above, the shape of cover unit (10) may be large enough in proportional so as to dissuade a user, train a user, or otherwise avoid the ability of a user to store cover unit (10) within user's pocket, jacket, or other clothing item so that the portable mobile device (10a) within cover unit (10) is not in close or prolonged proximity with user's face and/or body.

In the view of FIG. 10, the front case shell (11) is shown, and in this embodiment, front case shell (11) may be comprised of one or more camera interfaces (20) to allow such components of portable mobile device (10a) such as the camera lens to remain unblocked by cover unit (10) when portable mobile device (10a) is situated within cover unit (10). Also shown in this view in this embodiment, is hook (29) situated at the top portion of cover unit (10) to encourage a user to hang cover unit (10) upon other items, such as a user's purse, backpack, belt loop outside of a pant pocket, or briefcase instead of around a user's body. In one embodiment, hook (29) may be comprised of a metal material, durable plastic material, or other comparable material. Toward the upper portion of front case shell (11) is button (36) to allow a user to retract earphones (30) into cover unit (10).

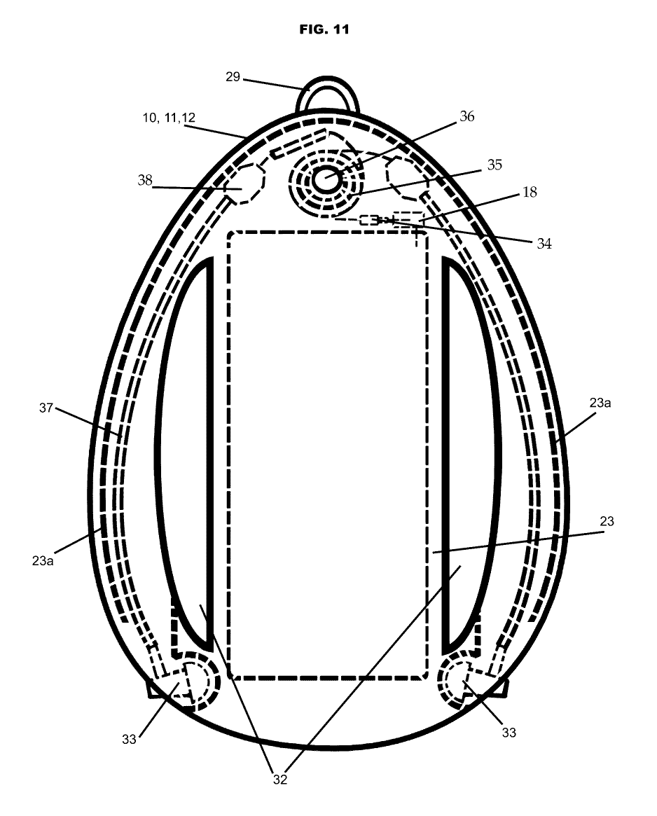

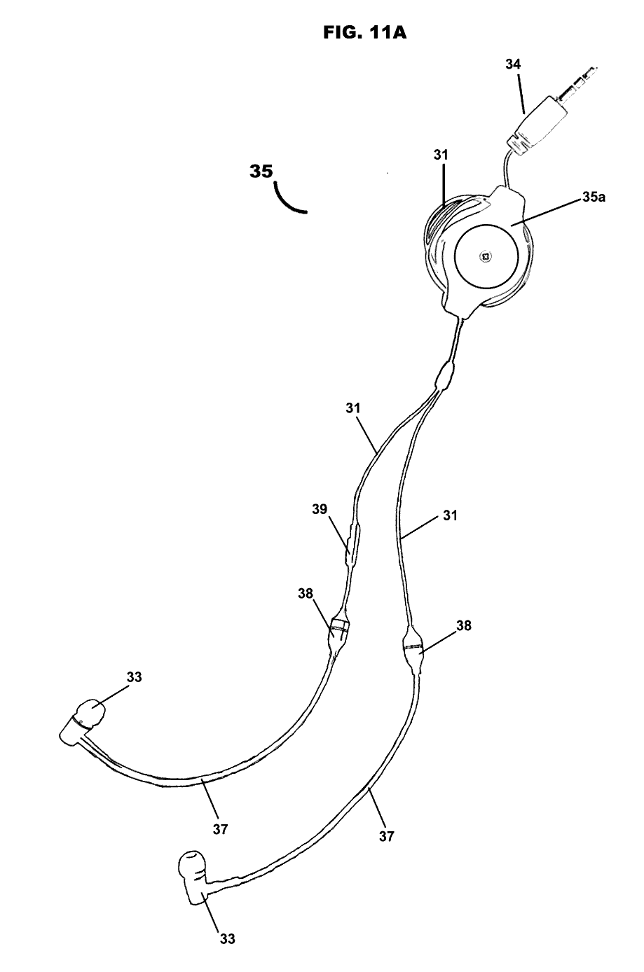

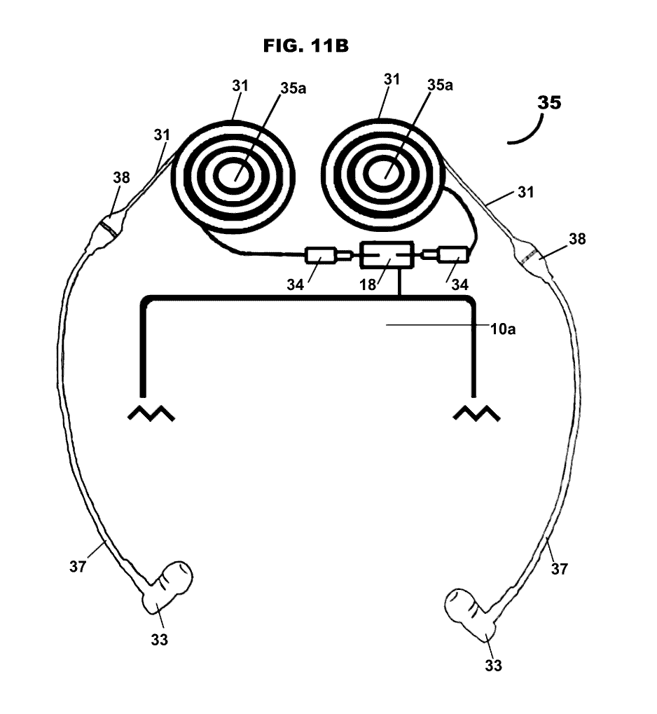

FIG. 11 illustrates a cross-sectional view of the embodiment discussed in FIG. 10, and showing the internal components encased within cover unit (10). In this view, phone cord cartridge (35) is situated at the upper compartment (13) within bottom case shell (12). Phone cord cartridge (35) may contain earphones (30) with one or more ear pieces (33). Each ear piece (33) of earphones (30) are situated on opposite sides of cover unit (10), and may be extended out from a spool (35a) of phone cord cartridge (35) in opposite directions when in use. Cord (31) of earphones (30) may be spooled within phone cord cartridge (35) in such a way as to allow each ear piece (33) to be extended out from cover unit (10) in opposite directions without tangling cord (31) during extension or retraction from phone cord cartridge (35). Alternatively, each ear piece (33) may be separately extended out from spool (35a) depending on a user's preference. In another embodiment, earphones (30) may contain a single ear piece (33).

Also shown in FIG. 11 are one or more interfaces (32) in the form of open areas of cover unit (10) to allow such audio components, antennas, and other control features of portable mobile device (10a), such as a speaker, volume control, and other control features to remain unblocked by cover unit (10) when portable mobile device (10a) is situated within cover unit (10). In this embodiment, there may be two audio interfaces (32) located on opposite sides of the area for placement of the portable mobile device (10a). Portable mobile device (10a) may be lodged within an inner wall area (23) of bottom case shell (12) that may be proportional in size to fit portable mobile device (10a) snugly therein. Bottom case shell (12) of cover unit (10) may also be comprised of an internal wall (23a) for housing phone cord cartridge (35), and may include microphone (39), tubing (37), and one or more ear pieces (33).

Also shown in this view is tubing (37) enclosing a portion of the cord (31) of earphones (30) that may come into contact with a user's face or body. At one end of tubing (37) of earphones (30) are one or more the ferrite beads (38). Ferrite beads (38) may be comprised of a hollow cylinder or bead shape composed of ferrite/iron oxide material.

Phone cord cartridge (35) may interface with an external speaker jack (18) via audio plug (34) that may allow for multiple earphones connection or a speaker connection to portable mobile device (10a).

FIG. 11A illustrates an embodiment of phone cord cartridge (35), which may be utilized in connection with any of the embodiments disclosed herein, and which may contain a plurality of ear pieces (33) in earphones (30).

FIG. 11B illustrates another embodiment of phone cord cartridge (35), which may be utilized in connection with any of the embodiments disclosed herein, and which may contain a plurality of spools (35a), each with a single ear piece (33) in each earphones (30). The plurality of spools (35a) may be rotatably fastened within upper compartment (13) of cover unit (10).

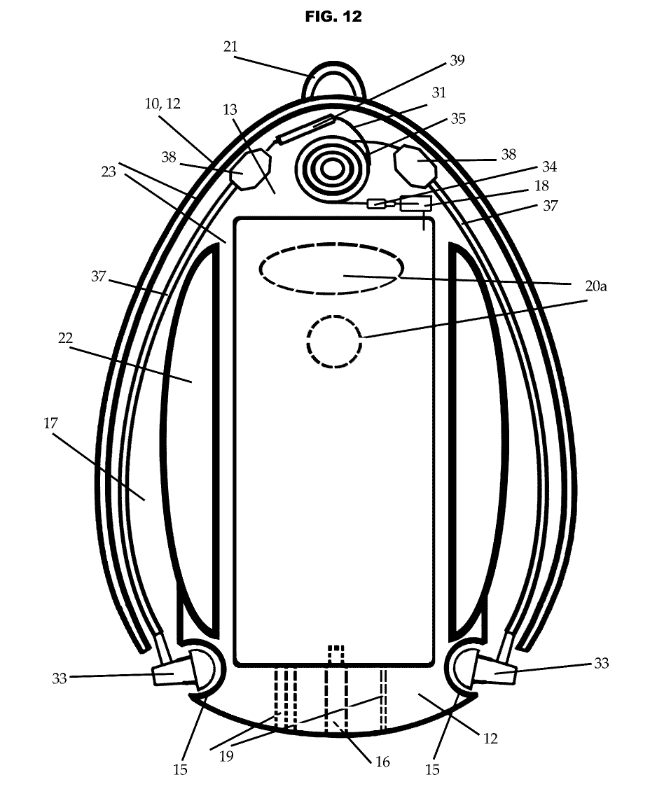

FIG. 12 illustrates a bottom view of the embodiment discussed in FIG. 10, and showing the internal components encased within cover unit (10), including a partial cross-section view of certain components for power and audio connectivity. In this view, one or more ear piece housings (15) are shown, and which may be utilized to position ear pieces (33) within cover unit (10) when not in use. Ear piece housing (15) provide a storage space of ear pieces (33) as well as protect against damage and wear and tear on ear pieces (33) and earphones (30).

Also present in this view is power port extension (16), which as previously explained, allows a user to charge the portable mobile device (10a) via such extension. This embodiment may also contain one or more channels (19) at the base of cover unit (10) so as not to block any speaker or other components of portable mobile device (10a). In this bottom view, bottom case shell (12) may be comprised of one or more camera interfaces (20a) (outlines only shown in this view) to allow such components of portable mobile device (10a) such as the camera lens to remain unblocked by front shell case (11) or bottom shell case (12) when portable mobile device (10a) is situated within cover unit (10).

As previously indicated above, bottom case shell (12) may be further comprised of an upper compartment (13), which in this embodiment may house phone cord cartridge (35). Also shown in this view is microphone (39) of earphones (30).

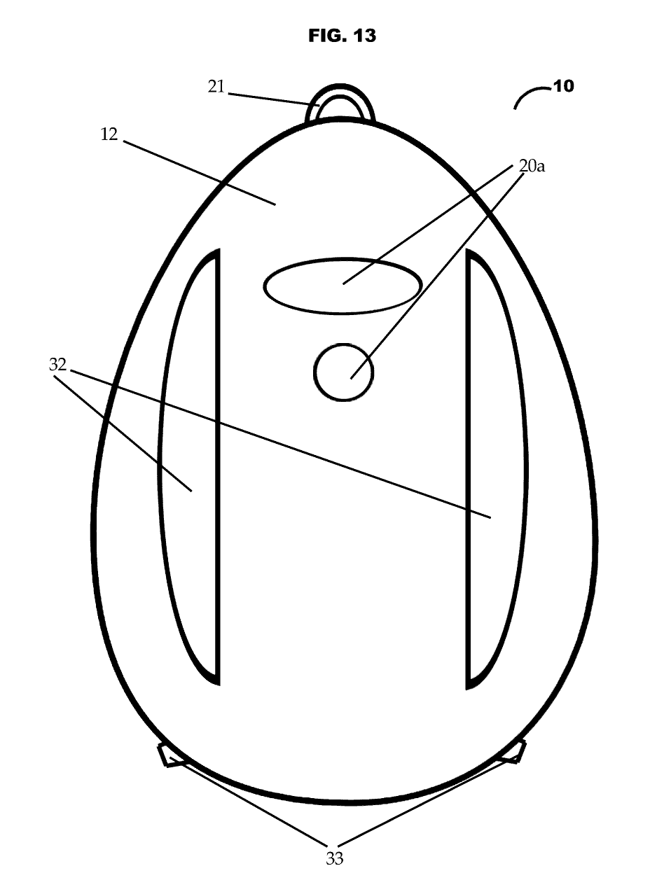

FIG. 13 illustrates the bottom view of bottom case shell (12) of cover (10). In this view, camera interfaces (20a) are shown and which may vary in shape and position depending on the particular model and brand of portable mobile device (10a) used with cover unit (10).

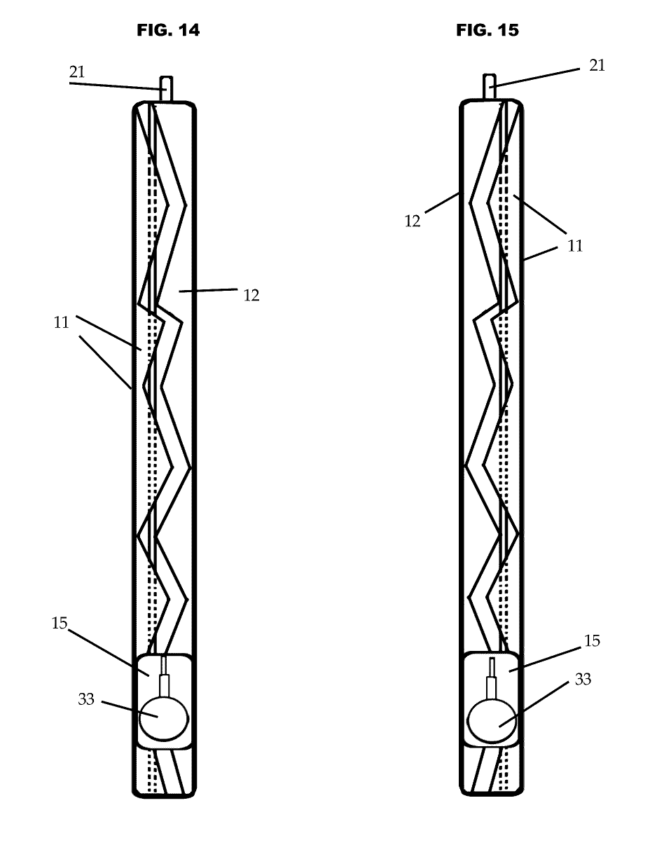

FIGS. 14 and 15 illustrate right (FIG. 14) and left (FIG. 15) side views of the cover unit (10) embodiment of FIG. 10. In this view, the sides of front case shell (11) and bottom case shell (12) are shown, and which may have a zip-zag pattern to connect to each other. Other designs may be employed in connection with front case shell (11) and bottom shell case (12) without deviating in scope from the present disclosure.

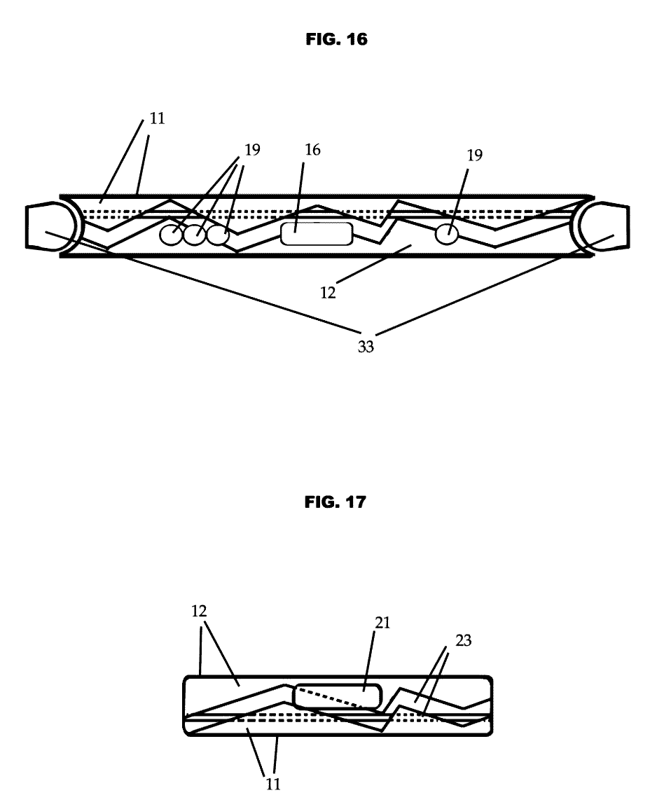

FIG. 16 illustrates a bottom side view of the cover unit (10) embodiment of FIG. 10. FIG. 17 illustrates a top side view of the cover unit (10) embodiment of FIG. 10.

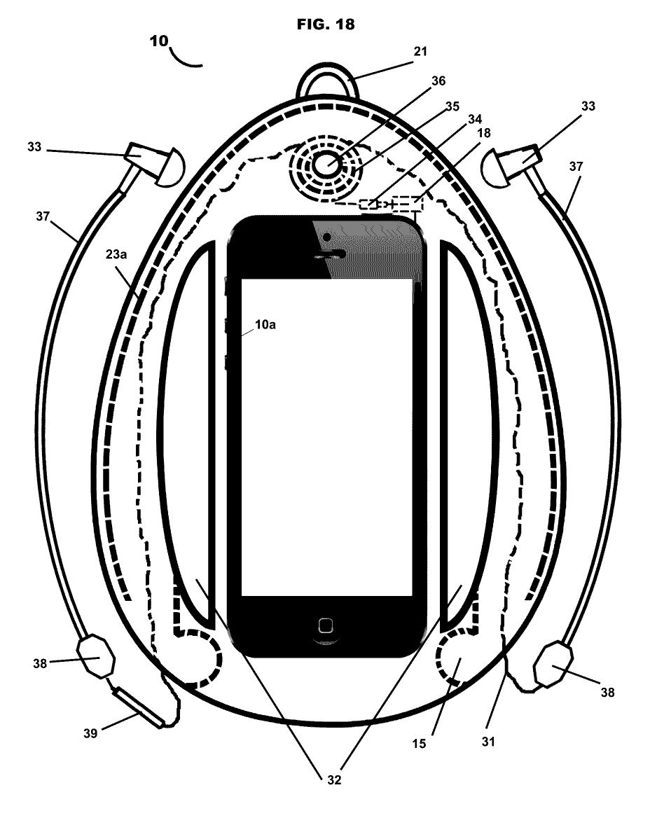

FIG. 18 illustrates an operational mode of cover unit (10) in which portable mobile device (10a) (shown in this view) may be utilized by a user, and showing earphones (30) in an extended state.

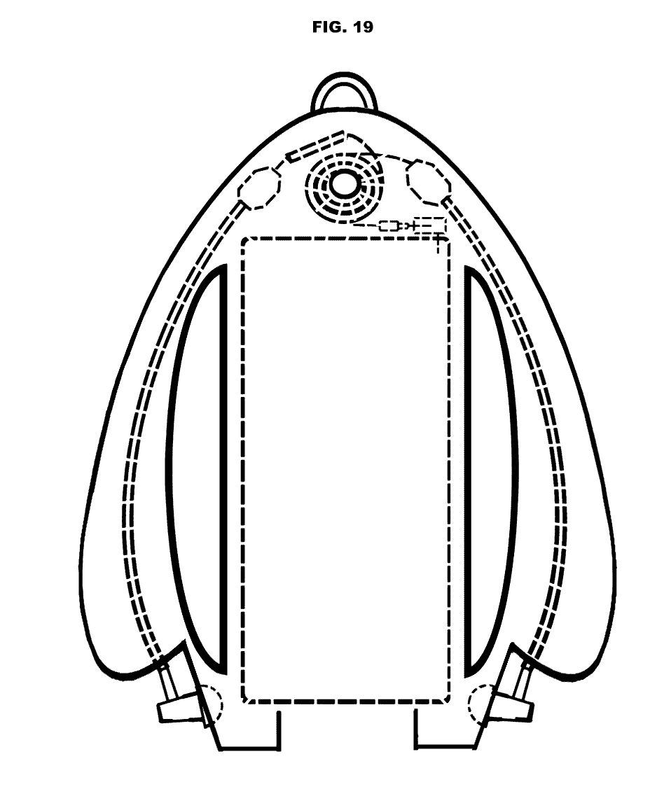

FIG. 19 illustrates another embodiment of an integrated cover unit (10) for a portable mobile device (10a) (not shown in this figure).

In using an embodiment of the integrated cover unit (10), a user may first remove front case shell (11) from bottom shell case (12) and position user's portable mobile device (10a) within the body housing (12a) of bottom shell case (12) by also connecting power port extension (16) into the power port of the portable mobile device (10). A user may then position phone cord cartridge (25) within the upper compartment (13) of bottom shell case (12), and proceed to connect audio plug (24) of earphones (20) in the portable mobile device (10a) while leaving the microphone (22), ear pieces (23), and tubing (27) positioned outside of bottom shell case (12). A user may then connect front case shell (11) atop of bottom shell case (12) and secure it in place. Once secured, a user may extend cord (21) out from around the spool (25a) of phone cord cartridge (25) in order to place each ear piece (23) in user's ear(s) for making a phone call, listening to music, or other activity. Once the user finishes with such activity, ear pieces (23) may be removed from user's ears, and user may engage button (26) to retract cord (21) around the spool (25a) of phone cord cartridge (25), and which retracting motion is stopped once the microphone (22) or tubing (27) is flush with the outside of front case shell (11) and bottom shell case (12). A user may then place ear pieces (23) into ear piece compartment (15) of bottom shell case (12) for storage.

In using another embodiment of the integrated cover unit (10), a user may first remove front case shell (11) from bottom shell case (12) and position user's portable mobile device (10a) within the body housing (12a) of bottom shell case (12) by also connecting power port extension (16) into the power port of the portable mobile device (10). A user may then position phone cord cartridge (35) within the upper compartment (13) of bottom shell case (12), and proceed to connect audio plug (24) of earphones (30) in the portable mobile device (10a) and further position the microphone (39), ear pieces (33), and tubing (37) within internal wall (23a) of bottom shell case (12). A user may then connect front shell case (11) atop of bottom shell case (12) and secure it in place. Once secured, a user may extend cord (31) out from around the spool (25a) of phone cord cartridge (35) in order to place each ear piece (33) in user's ear(s) for making a phone call, listening to music, or other activity. Once the user finishes with such activity, ear pieces (33) may be removed from user's ears, and user may engage button (36) to retract cord (31) around the spool (25a) of phone cord cartridge (35), and which retracting motion is stopped at the microphone (39) or tubing (27). A user may then place ear pieces (33) into ear piece housings (15) of bottom shell case (12) for storage.

While particular forms of the invention have been illustrated and described, it will also be apparent to those skilled in the art that various modifications can be made without departing from the spirit and scope of the invention. Accordingly, it is not intended that the invention be limited except by the claims.

What is claimed is:

1) An integrated cover unit for a portable mobile device, comprising:
a multi-piece housing for said portable mobile device; and
a retractable earphone unit removably coupled to an inner portion of said cover.

2) The unit of claim 1, wherein said cover further comprises a top piece and a bottom piece.

3) The unit of claim 1, wherein said retractable earphone unit further comprises a spool and an earphone set, and further wherein said earphone set further comprises an audio plug, an electrical cord, a microphone, a plurality of ferrite beads, hollow tubing, and a plurality of ear pieces.

4) The unit of claim 3, wherein said cord of said earphones are configured to wrap around said spool.

5) The unit of claim 4, wherein said tubing is couple between each of said plurality of ear pieces and said plurality of ferrite beads.

6) The unit of claim 5, wherein said tubing is comprised of a flexible plastic material.

7) The unit of claim 6, wherein said earphones may be extended out from said spool and partially retracted around said spool up until said microphone.

8) An integrated cover unit for a portable mobile device, comprising:
a one-piece housing for said portable mobile device; and
a retractable earphone unit removably coupled to an inner portion of said cover.

9) The unit of claim 8, wherein said cover further comprises a compartment door for allowing a user to situate said retractable earphone unit within said inner portion of said cover.

10) The unit of claim 9, wherein said retractable earphone unit further comprises a spool and an earphones set, and further wherein said earphone set further comprises an audio plug, an electrical cord, a microphone, a ferrite bead, a hollow tubing, and an ear piece.

11) The unit of claim 10, wherein said cord of said earphones are configured to wrap around said spool.

12) The unit of claim 11, wherein said tubing is comprised of a flexible plastic material.

13) The unit of claim 11, wherein said earphones may be extended out from said spool and partially retracted around said spool up until said microphone.

14) An integrated cover unit for a portable mobile device, comprising:
a housing for said portable mobile device;
a retractable earphone unit removably coupled to an inner compartment of said cover; and
wherein said cover further comprises an internal housing for an earphone set of said retractable earphone unit.

15) The unit of claim 14, wherein said retractable earphone unit further comprises a spool and an earphone set, and further wherein said earphone set further comprises an audio plug, an electrical cord, a microphone, a plurality of ferrite beads, hollow tubing, and a plurality of ear pieces.

16) The unit of claim 15, wherein said cord of said earphones are configured to wrap around said spool.

17) The unit of claim 16, wherein said tubing is coupled between each of said plurality of ear pieces and said plurality of ferrite beads.

18) The unit of claim 16, wherein said earphones may be extended out from said spool and partially retracted around said spool.
